(19) United States
(12) Patent Application Publication
(10) Pub. No.: US 2005/0198114 A1
(43) Pub. Date: Sep. 8, 2005

(54) Communication system and protocol for an interactive portable device

(76) Inventors: Keith Lucas, Half Moon Bay, CA (US); Jeff Holt, Redwood City, CA (US); Dirk Bartels, Cupertino, CA (US)

Correspondence Address: PERKINS COIE LLP, P.O. BOX 2168, MENLO PARK, CA, 94026, US

(21) Appl. No.: 10/758,712

(22) Filed: Jan. 15, 2004

(51) Int. Cl. G06F 15/16

(52) U.S. Cl. 709/203; 709/230

(57) ABSTRACT

A communication system for an interactive device includes a data conduit operative for transferring XML formatted data. An Internet framework, coupled to a first end of the data conduit, is operative for sending and receiving XML formatted data. Also included is an interactive device framework of the interactive device, coupled to a second end of the data conduit, operative for sending and receiving XML formatted data.

### FIELD OF THE INVENTION

The present invention relates to communication protocols and more particularly to communication-protocols for an interactive portable device.

### BACKGROUND OF THE INVENTION

The popularity of portable handheld devices has skyrocketed in the last several years. These devices offer mobile computing via a multitude of applications. Some examples of these applications include word processing, compilers, email and games.

Another popular use of a handheld device is applications for data entry of specific activities. For example, an application that records data from an exercise regimen or a food diary/calorie tracker. While these types of programs offer obvious advantages via the portable handheld device, use of collected data is, for most purposes, locked into that application. As a result, the collected data is not easily exportable to other more robust applications. In fact, the associated data can usually only be archived via the resident backup services of the handheld device.

Another drawback of handheld data collection applications is that they typically will not offer additional information to aid a user regarding a particular activity. For example, a person may be entering a diary of food intake for purposes of calorie tracking. During data entry, the person may desire nutritional information on a particular type of food. More than likely, the application will not be able to satisfy this curiosity. At the very least it will probably provide very limited information that could very likely be out of date.

In view of the foregoing, it is readily seen that a need exists for a new data protocol that allows for easy data input via an interactive portable device yet still allows the archived data to be easily manipulated in external, more robust applications. In addition, mechanisms that can deliver more information to a user are also highly desirable.

### SUMMARY OF THE INVENTION

A communication system for an interactive device, in accordance with the present invention, includes a data conduit operative for transferring XML formatted data. An Internet framework, coupled to a first end of the data conduit, is operative for sending and receiving XML formatted data. Also included is an interactive device framework of the interactive device, coupled to a second end of the data conduit, operative for sending and receiving XML formatted data.

A communication method for an interactive device, in accordance with the present invention, includes initiating a transfer of XML formatted data from an interactive device framework of the interactive device. The XML formatted data is received at a data conduit, coupled to one end of the interactive device, and then transferred over the data conduit. The XML formatted data is then received at an Internet framework coupled to a second end of the data conduit.

An advantage of the present invention is that data collected via a portable device can be used in other applications for more meaningful purposes. In addition, the data structure of the present invention allows for multimedia files to be appended to an object or referenced and then delivered via other means (CD, DVD, etc) that results in a rich user experience.

These and other advantages of the present invention will become apparent to those skilled in the art after reading the following descriptions and studying the various figures of the drawings.

### BRIEF DESCRIPTION OF THE DRAWINGS

FIG. 1 is a block diagram of a communications system, in accordance with the present invention.

FIG. 2 is a detailed block diagram of a suitable hardware implementation for supporting the Internet framework of FIG. 1, in accordance with the present invention.

FIG. 3 illustrates an example portable device for supporting the handheld framework of the communication system of FIG. 1, in accordance with the present invention.

FIG. 4 illustrates an exercise template, an exercise definition and an exercise instance, in accordance with the present invention.

FIG. 5 illustrates examples of exercise templates, in accordance with the present invention.

FIGS. 6A and 6B illustrate examples of exercise definitions, in accordance with the present invention.

FIG. 7A illustrates an exercise instance before execution, in accordance with the present invention.

FIG. 7B illustrates an exercise instance after execution, in accordance with the present invention.

FIG. 8 illustrates a generic workout definition and generic workout instance, in accordance with the present invention.

FIGS. 9A and 9B illustrate example implementations of a workout definition, in accordance with the present invention.

FIGS. 10A and 10B illustrate example implementations of a workout instance, in accordance with the present invention.

FIG. 11 illustrates a generic program definition and a generic program instance, in accordance with the present invention.

FIGS. 12A and 12B illustrate example implementations of a program definition, in accordance with the present invention.

FIGS. 13A and 13B illustrate example implementations of a program instance, in accordance with the present invention.

FIG. 14 illustrates an example implementation of an exercise library, in accordance with the present invention.

FIG. 15 illustrates an example implementation of a workout library, in accordance with the present invention.

FIG. 16 illustrates an example implementation of a program library, in accordance with the present invention.

FIG. 17 is a flowchart illustrating a communication method for an interactive device, in accordance with the present invention.

### DETAILED DESCRIPTION OF THE INVENTION

The present invention contemplates a variety of communication systems, methods and protocols for an interactive portable device. For example, the present invention teaches a system and method for an interactive device that allows the transferred data to be used in a meaningful way, besides mere archiving.

This is achieved by providing a communication protocol, based on XML, designed to standardize the representation of data for communication between applications. The type of data is not limited to any particular type, but in a preferred embodiment fitness data is the primary focus of the present invention. Through the use of the XML standard, data delivery, collection, tracking and processing are all simplified. As a result, seamless application interoperability is achieved.

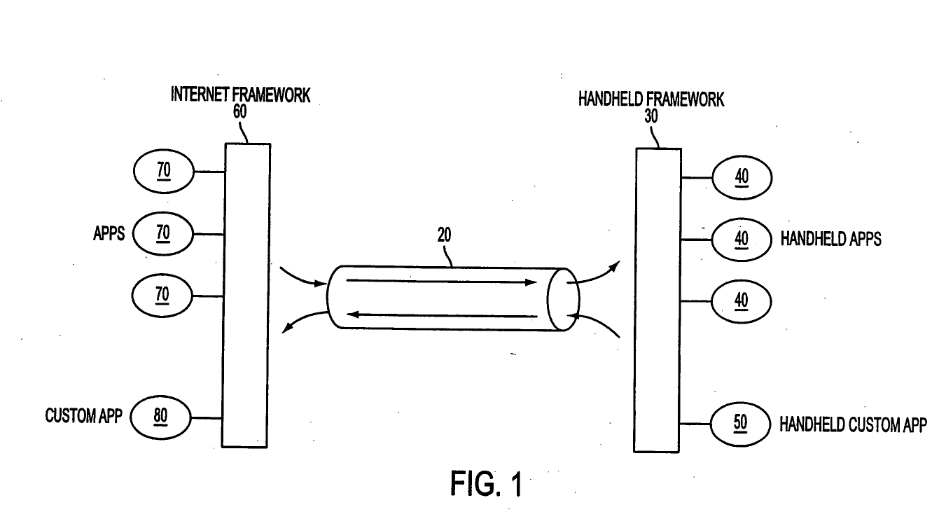

FIG. 1 is a block diagram of a communications system 10, in accordance with the present invention. Communications system 10 includes a data conduit 20, a handheld framework 30 that includes handheld applications (handheld apps) 40 and optionally handheld custom application(s) 50, and an Internet framework 60 that includes applications (apps) 70 and optionally custom application(s) 80. In practice, XML formatted data flows in a bidirectional fashion between handheld framework 30 and Internet framework 60, via data conduit 20. Since data is formatted in XML, it can be used interchangeably with applications of varying types, specifically applications 40, 50, 70 and 80. Data conduit 20 can take the form of any appropriate data transfer mechanism such as universal serial bus, firewire (IEEE standard 1394), wireless and the like.

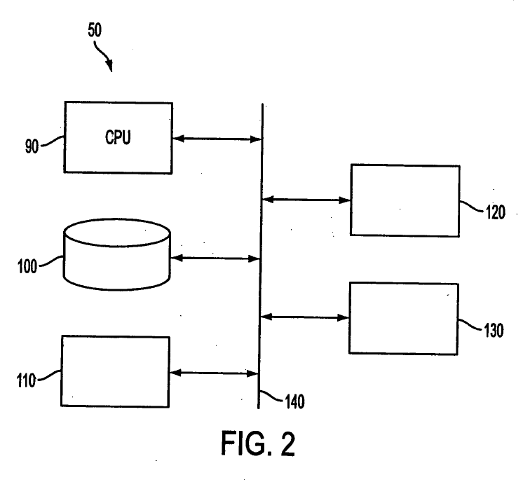

FIG. 2 is a detailed block diagram of a suitable hardware implementation for supporting the Internet framework 60 of FIG. 1, in accordance with the present invention. Internet framework 60 includes a central processing unit (CPU) 90, a persistent storage device 100 such as a hard disk, a transient storage device 110 such as random access memory (RAM), a network I/O device 120, and a encryption device 130—all bi-directionally coupled via a databus 140. As will be readily apparent, the Internet framework 60 is typical of computer systems and as a result is readily implementable on prior art hardware systems. Other additional components such as a graphics card, I/O devices such as a video terminal, keyboard and pointing device, may be part of the Internet framework 60. One skilled in the art will readily recognize that framework 60 is but one possible implementation. As such, numerous permutations can be made without departing from the true spirit and scope of the present invention.

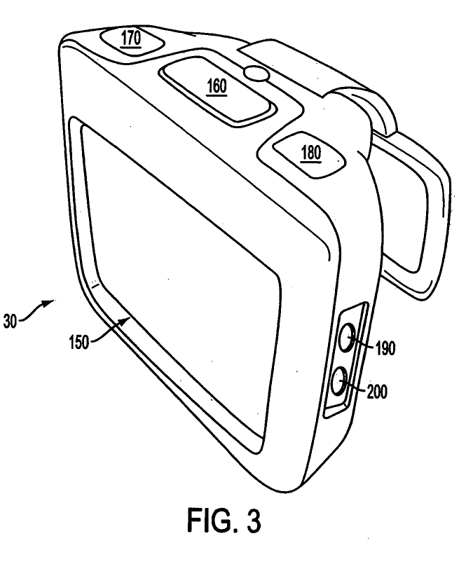

FIG. 3 illustrates an example portable device for supporting the handheld framework 30 of the communication system 10 of FIG. 1, in accordance with the present invention. Included in portable device/handheld framework 30 is a screen 150, a select button 160, a mode/menu button 170, a pause/back button 180, volume up/down buttons 190 and 200. In addition, scroll up and scroll down buttons can also be included. One skilled in the art will readily recognize the implementation of handheld device 30 is but one possible variant and that other configurations are possible without departing from the true spirit and scope of the present invention. In the context of the present invention, it should be understood that the phrases “handheld device” and “portable device” and permutations thereof can be used interchangeably and all refer to a mobile computing device that can fit in the palm of a hand. In addition, the phrase “interactive device” can include a “portable device” but is not necessarily limited to that class of devices.

Also in the context of the present invention, several concepts will now be defined that will aid in comprehension. An exercise is a single action that is performed one or more times. In the most general case, an exercise contains a set count, quantifiers and description. A workout is a series of one or more exercises executed in succession over a continuous period of time on a given day. A program is a schedule of individual workouts, typically designed to produce specific physiological effects over a period of time.

Each of these three items (exercise, workout and program) are represented as objects. Each of these objects can also be associated with multimedia files such as text (plain text, html), audio (MP3, WAV), video (MPG, AVI) and image (JPG, GIF). One skilled in the art will realize that this list is merely illustrative and that multimedia files of types other than the ones listed can be associated with the objects. One skilled in the art will also appreciate that the ability to include multimedia files with the objects is particularly advantageous since the ability to transmit relevant, up-to-date information to an end user is greatly increased.

In addition, multiple levels can be defined for a single item. Levels define various “loads” (reps, weights, time, pace, etc) and are used to target a given exercise, workout, or program at an individual of a specific ability.

Categories are used to tag exercises, workouts and programs. Categorizations can be flat (Run Routes=Power Poles, Los Gatos Creek Trail, Bair Island Loop, etc.) or hierarchical (Muslce Groups=Upper Body-Chest, Upper Body-Biceps, Lower Body-Calves, etc.)

In further regard to the aforementioned exercise concept, an exercise is composed of multiple sets. A set is composed of multiple activities. An activity is composed of multiple instructions and an instruction is composed of a number a unit and an optional string descriptor.

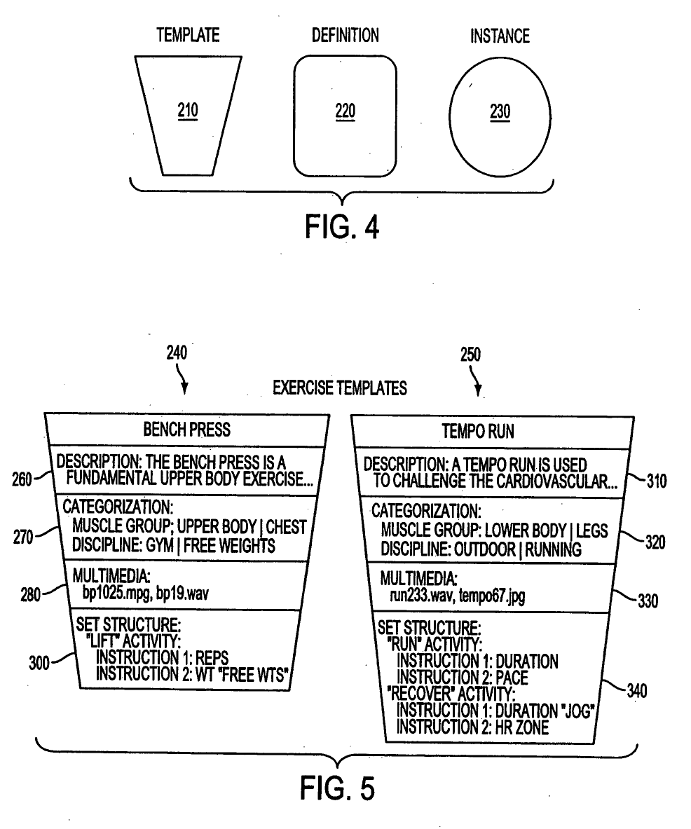

FIG. 4 illustrates an exercise template 210, an exercise definition 220 and an exercise instance 230, in accordance with the present invention. The exercise template 210 is the most generic way of identifying an exercise, the exercise definition 220 is more specific and the exercise instance 230 is most specific.

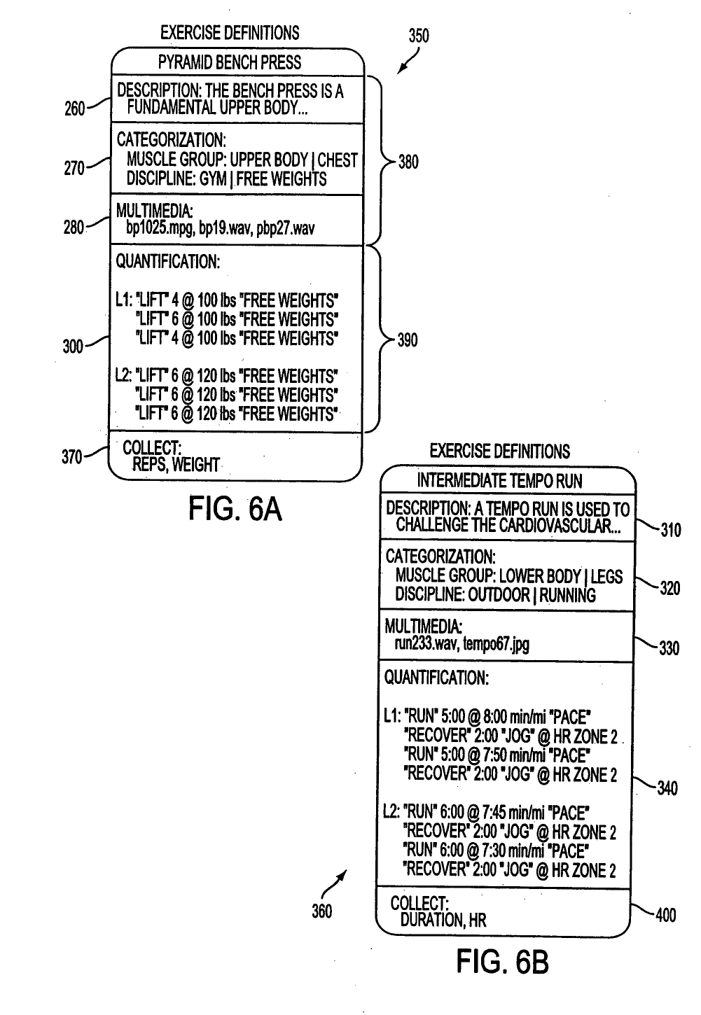

FIG. 5 illustrates examples of exercise templates (240 and 250), in accordance with the present invention. An exercise template defines the basic elements of a particular exercise. It allows an activity to be “described” without being “prescribed”. An exercise template describes the exercises, categorizes it, details how to perform it (using multimedia) and defines how sets are instructed and quantified without actually quantifying them. In addition, templates provide a structured description and facilitate the creation of definitions and instances.

Example template 240 is entitled “Bench Press” and has a description 260, a categorization 270, multimedia file(s) 280 and a set structure 300. In this particular example, the description 260 gives a general definition of a bench press, the categorization 270 defines what parts of the body are affected by the bench press, where it is performed and what sort of equipment to use. Multimedia file 280 lists a video MPG file and an audio WAV file—both of which contain instructional information on how to properly perform a bench press exercise. Set structure 300 lists the actual instructions on how to proceed with the bench press exercise.

Example template 250 similarly includes a description 310, a categorization 320, multimedia file(s) 330 and a set structure 340 for the exercise entitled “Tempo Run”.

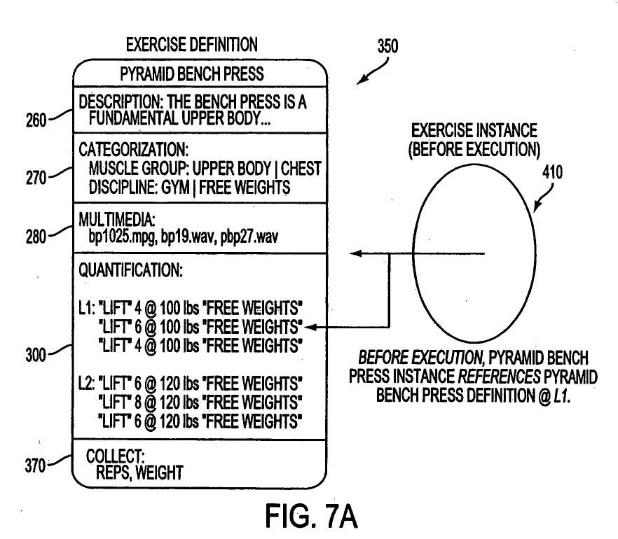

FIGS. 6A and 6B illustrate examples of exercise definitions (350 and 360), in accordance with the present invention. An exercise definition encapsulates all information required to prescribe an activity for execution. An exercise definition defines the description, categorization and how-to (multimedia) information found in an exercise template. In addition, it quantifies the activity at one or more levels and defines the data to be collected during its execution. Exercise definitions are usually created from an existing exercise template, however, that is not a requirement. Once created, there is no link between the exercise definition and its exercise template of origin. Exercise definitions define the exercise and are often the basis of exercise instances and will be subsequently explained (exercise instances either reference exercise definitions or copy data from them).

Example definition 350 includes the same components as template 240 and additionally includes a collect segment 370 that specifies information to collect after the exercise is completed. The information indicated by bracket 380 includes information copied from template 240. However, definitions are not tied to templates. As a result, any of the data within definition 350 can be modified without affecting template 240. In this particular example, an additional WAV file was added.

Quantification information is expanded in definition 350. Regarding bracket 390, quantification information (at one or more levels) is generated to fill in the set structure obtained from template 240.

Example definition 360 similarly includes the description 310, categorization 320 and multimedia 330 copied from template 250. Additionally, quantification 340 is expanded and a collect segment 400 is similarly included.

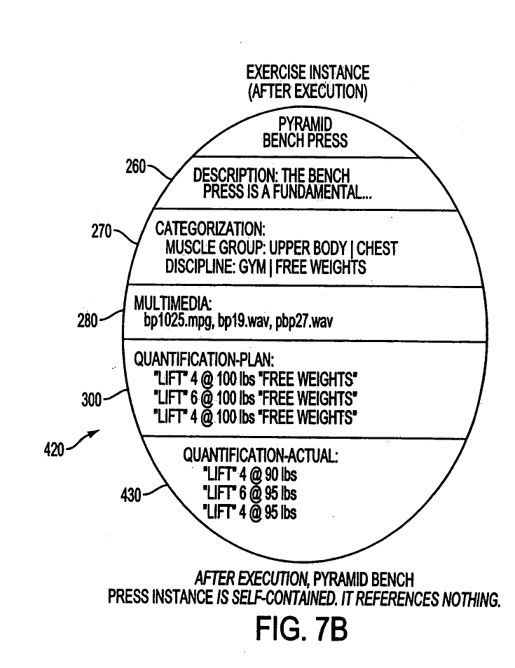

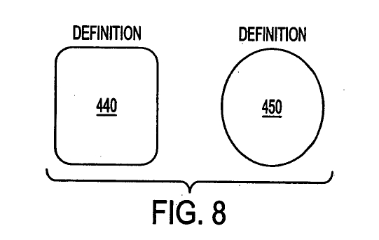

FIG. 7A illustrates an exercise instance 410 before execution, in accordance with the present invention. The exercise instance 410 represents an occurrence of an exercise (typically within the context of a workout instance) that is to be or has already been executed. Exercise instances are flexible in that they support containment of all exercise information within the instance or referencing of an externally defined exercise definition. An exercise instance 410 will usually be generated initially with a reference to an exercise definition 350 (plus a targeted level within that definition). This referencing enables automatic updating of all scheduled exercise instances when an exercise definition is somehow changed (for example, a new video file is added). More importantly, the definition reference plus level enables easy adjustment of exercise load (reps, weight, time, pace, etc) through increment/decrement of the largest definition level.

FIG. 7B illustrates an exercise instance 420 after execution, in accordance with the present invention. When an exercise instance 420 is executed, all descriptive information (260, 270, and 280) and the target level quantification information 300 are copied from the referenced exercise definition 350 into the exercise instance 420. The exercise definition reference is then removed and the exercise instance 420 permanently captures thereafter exactly what had been planned. This allows modification of the exercise definition without the possibility of corrupting exercise instances and vice versa. Exercise instances also store “actual” quantification data 430 that was collected during execution.

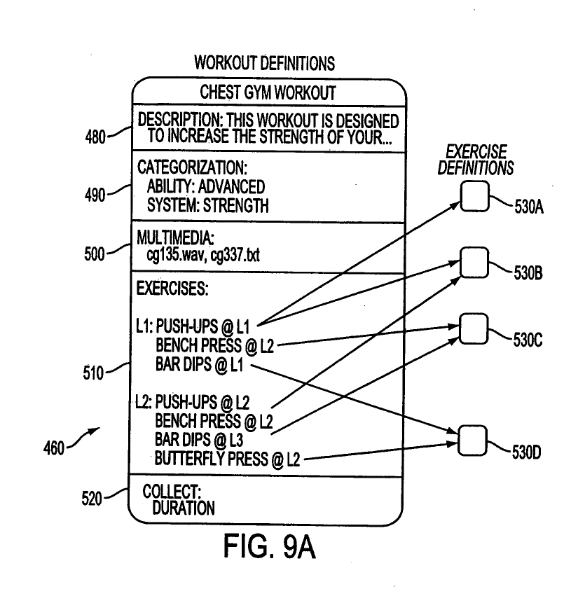

FIG. 8 illustrates a generic workout definition 440 and generic workout instance 450, in accordance with the present invention. As previously stated, a workout is a series of one or more exercises executed in succession over a continuous period of time on a given day. Additionally, a workout contains a description, an instruction and exercise information. Similar to the exercise concept, the workout definition 440 is more general and the workout instance 450 is more specific.

The workout definition 440 encapsulates all information required to prescribe a workout for execution. A workout definition defines description, categorization and multimedia information. In addition, it also contains or references one or more exercise definitions and specifies what workout-level data should be collected during execution. The workout definition 440 may define multiple levels of execution. Each workout level can reference an arbitrary exercise definition at an arbitrary exercise level, regardless of the references made by other workout levels. For example, a higher level workout may include more exercises in addition to higher levels within those exercises than a lower level of the same workout. Workout definitions define the workout and are often the basis for creation of workout instances.

The workout instance 450 represents an occurrence of a workout (either within the context of a program instance or not) that is to be or has already been executed. The workout instance 450 is usually generated from a workout definition (at a single workout level) when the workout is prescribed for execution and it contains essentially all information that the workout definition contains: description, categorization, multimedia information and exercise references. Whereas workout definitions reference exercise definitions, workout instances reference exercise instances. Additionally, workout instances contain a planned date of execution and any collected workout data (such as total workout time). In addition, each exercise instance referenced by it will also contain collected exercise data specific to it.

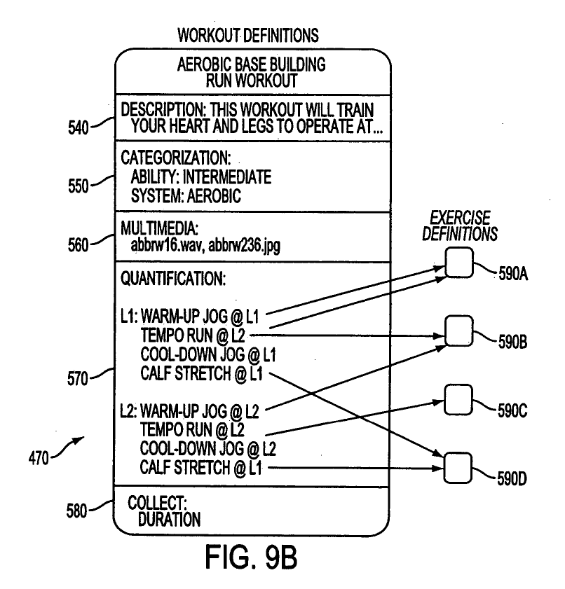

FIGS. 9A and 9B illustrate example implementations of a workout definition (460 and 470), in accordance with the present invention. Included in definition 480 is a description 480, a categorization 490, multimedia 500, exercises 510 and a data collection segment 520. As previously indicated, a workout definition is made up of one or more exercises (530A, 530B, 530C and 530D). The data collected in segment 520 encompasses workout level quantities generated by executing the workout, for example the duration of the workout.

Similarly to workout definition 460, definition 470 also includes a description 540, a categorization 550, multimedia 560, quantification 570 and a data collection segment 580. Additionally, workout definition 460 is made up of individual exercises 590A, 590B, 590C and 590D.

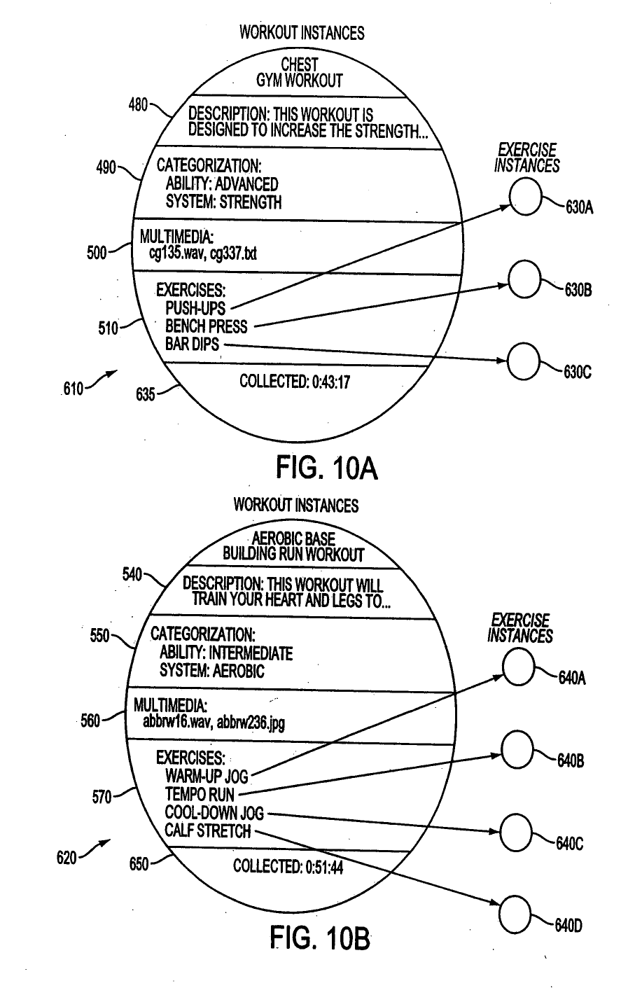

FIGS. 10A and 10B illustrate example implementations of a workout instance (610 and 620), in accordance with the present invention. In a similar fashion to definitions 460 and 470, instances 610 and 620 have descriptions (480, 540), categorization (490, 550), multimedia (500, 560) and exercises (510, 570). As previously stated, workout instances reference exercise instances as indicated by exercise instances 630A, 630B, 630C, 640A, 640B, 640C and 640D. Finally, instances 610 and 620 also store “actual” quantification data 635 and 650 that was collected during execution.

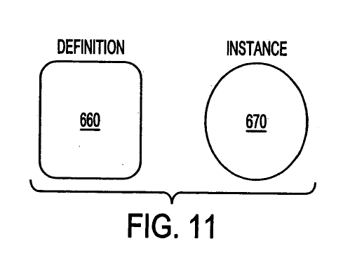

FIG. 11 illustrates a generic program definition 660 and a generic program instance 670, in accordance with the present invention. Similar to exercises and workouts, a definition is more general and an instance is more specific. The program definition 660 encapsulates all information required to prescribe a program for execution. Definition 660 typically defines description, categorization and multimedia information. In addition, it also contains or references one or more workout definitions.

Program definition 660 will typically define multiple levels of execution. Each program level can reference an arbitrary workout definition at an arbitrary workout level, regardless of the references made by other program levels. For example, a higher level program may include more workouts in addition to higher levels with those workouts than a lower level of the same programs. In addition, program definitions define the program and are often the basis for creation of program instances.

Program instance 670 represents an assigned program. In general, instance 670 is generated from a program definition (at a single program level) when the program is chosen for execution and it contains essentially all information that the program definition contains. This information includes description, categorization, multimedia information and workout references. Whereas program definitions reference workout definitions, program instances reference workout instances.

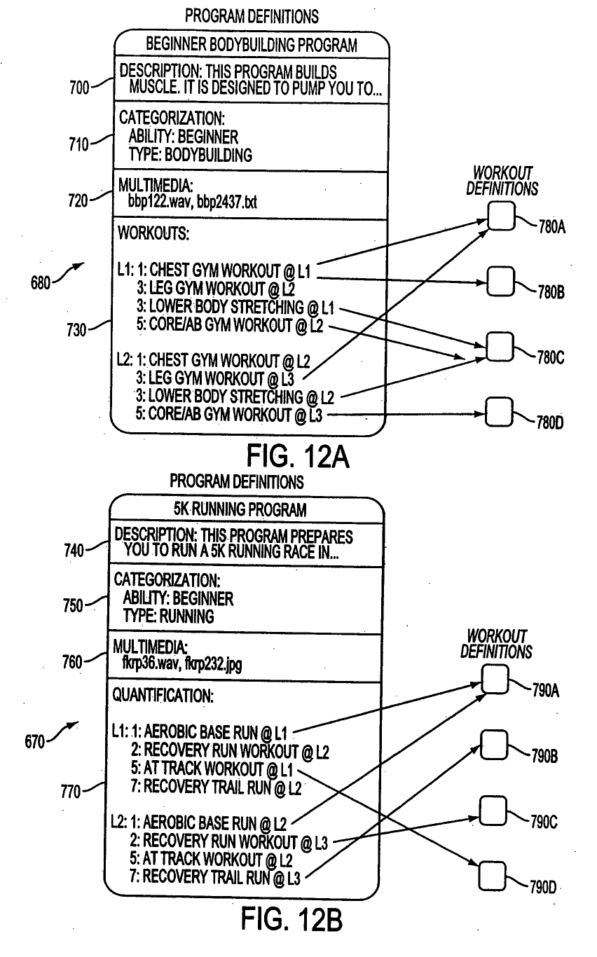

FIGS. 12A and 12B illustrate example implementations (680 and 690) of a program definition, in accordance with the present invention. Included are descriptions (700, 740), categorizations (710, 750), multimedia (720, 760), and quantifications (730, 770). As previously stated, program definitions can reference workout definitions as indicated by workout definitions 780A, 780B, 780C, 780D, 790A, 790B, 790C and 790D.

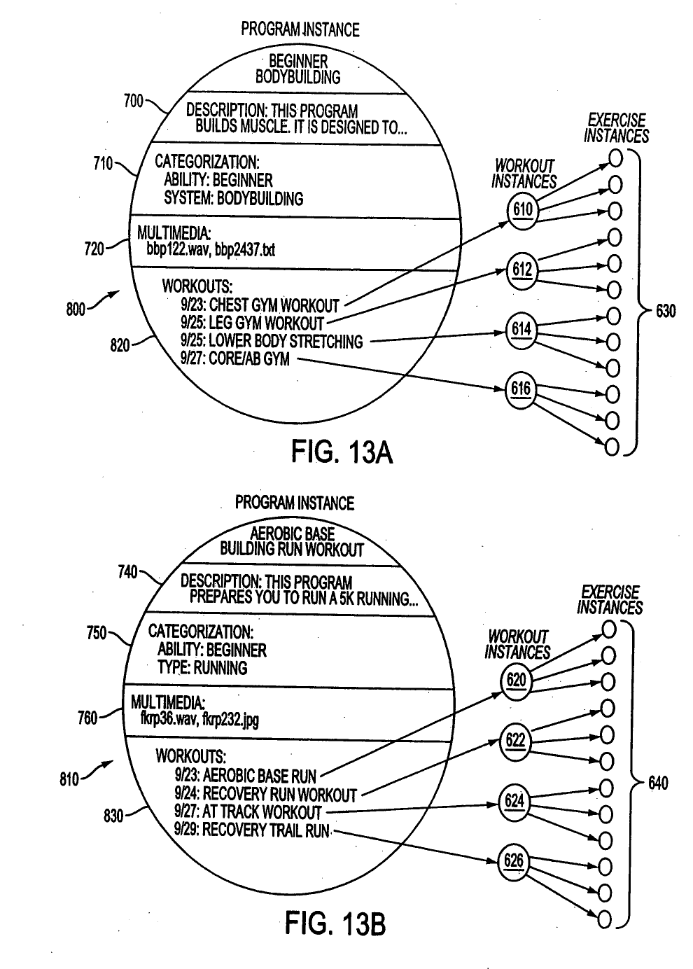

FIGS. 13A and 13B illustrate example implementations (800 and 810) of a program instance, in accordance with the present invention. Included in instances 800 and 810 are descriptions (700, 740), categorizations (710, 750) and multimedia (720, 760). Also included are lists of workouts (820, 830) that reference workout instances (610, 612, 614, 616, 620, 622, 624 and 626) that in turn reference exercise instances 630 and 640.

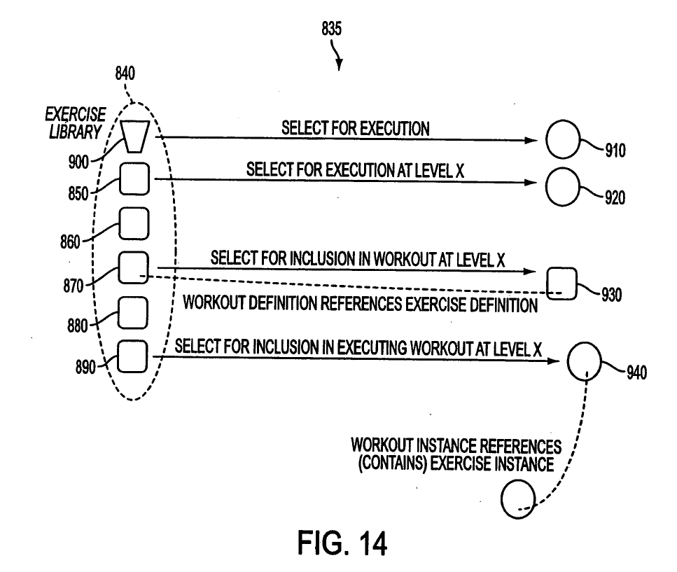

FIG. 14 illustrates an example implementation 835 of an exercise library 840, in accordance with the present invention. Library 840 contains exercise definitions (850, 860, 870, 880 and 890) and optionally an exercise template 900. In practice, a user can browse the exercise library 840 when looking for an exercise to execute or to add a workout. Some of the various choices a user can make includes select an exercise template 900 for execution 910, select an exercise definition 850 for execution at a level X (where ‘X’ is a number) 920 and select an exercise definition 870 for inclusion in a workout at a level X 930 wherein a workout definition references an exercise definition. Also included is a select exercise definition 890 for inclusion in executing workout at level X 940 wherein a workout instance references/contains an exercise instance.

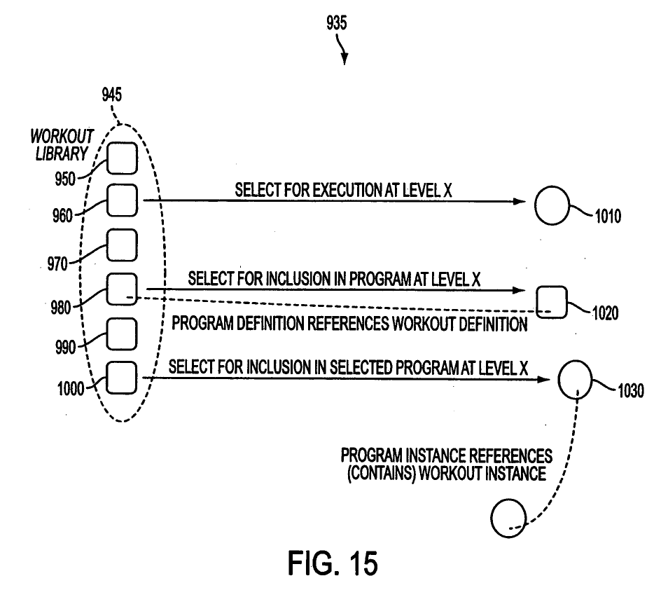

FIG. 15 illustrates an example implementation 935 of a workout library 945, in accordance with the present invention. Library 945 contains workout definitions (950, 960, 970, 980, 990 and 1000), each containing levels of prescription. Users can browse the workout library 945 when looking for a workout to execute or to add a program. Some example actions that can be taken include selecting workout definition 960 for execution at a level X 1010 and select workout definition 980 for execution at a level X 1020 where a program definition references a workout definition. Another action that can be done is select workout definition 1000 for inclusion in a selected program at a level X wherein a program instance references/obtains a workout instance.

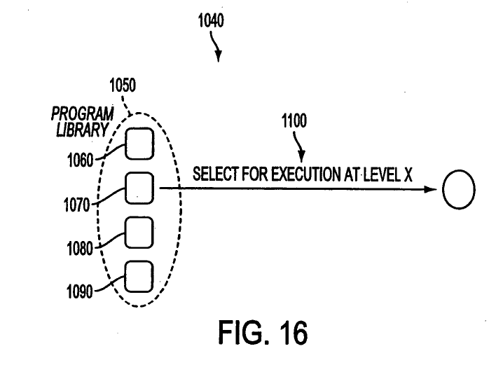

FIG. 16 illustrates an example implementation 1040 of a program library 1050, in accordance with the present invention. Program library 1050 contains multiple levels of prescription/program (1060, 1070, 1080 and 1090). Users browse the library 1050 when looking for a program (1060, 1070, 1080 and 1090) to execute. For example, action 1100 selects program 1070 for execution at a level X.

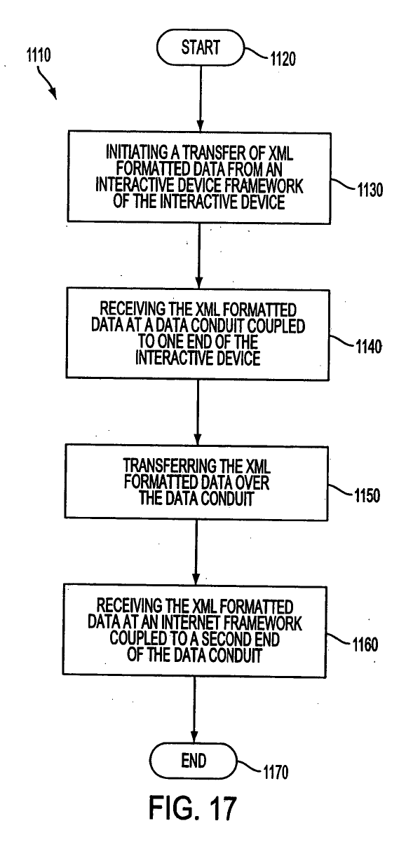

FIG. 17 is a flowchart illustrating a communication method 1110 for an interactive device, in accordance with the present invention. After a start operation 1120, an XML formatted data transfer is initiated from an interactive device framework of an interactive device at operation 1130. At operation 1140, the XML formatted data is received at a data conduit coupled to one end of the interactive device. The XML formatted data is then transferred over the data conduit, at operation 1150, and is received at an Internet framework coupled to a second end of the data conduit, at operation 1160. The method then ends at operation 1170.

An advantage of the present invention is that data collected via a portable device can be used in other applications for more meaningful purposes. In addition, the data structure of the present invention allows for multimedia files to be appended to object that results in a rich user experience.

While this invention has been described in terms of certain preferred embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention.

1. A communication system for an interactive device comprising:
a data conduit operative for transferring XML formatted data;
an Internet framework, coupled to a first end of the data conduit, operative for sending and receiving XML formatted data; and
an interactive device framework of the interactive device, coupled to a second end of the data conduit, operative for sending and receiving XML formatted data.

2. A communication system for an interactive device as recited in claim 1 wherein the Internet framework further comprises applications that utilize the XML formatted data.

3. A communication system for an interactive device as recited in claim 1 wherein the interactive device framework further comprises applications that utilize the XML formatted data.

4. A communication system for an interactive device as recited in claim 1 wherein the interactive device is a handheld device.

5. A communication system for an interactive device as recited in claim 1 wherein the XML formatted data comprises an exercise object, a workout object and a program object.

6. A communication system for an interactive device as recited in claim 5 wherein the exercise object, the workout object and program object further comprise multimedia instructions.

7. A communication system for an interactive device as recited in claim 5 wherein the exercise object further comprises a template, a definition and an instance.

8. A communication system for an interactive device as recited in claim 5 wherein the workout object further comprises a definition and an instance.

9. A communication system for an interactive device as recited in claim 5 wherein the program object further comprises a definition and an instance.

10. A communication system for an interactive device as recited in claim 5 wherein the workout object is comprised of a plurality of exercise objects.

11. A communication system for an interactive device as recited in claim 10 wherein the program object is comprised of a plurality of workout objects.

12. A communication system for an interactive device as recited in claim 1 wherein the XML formatted data conduit transfers the XML formatted data via a universal serial bus-type standard.

13. A communication system for an interactive device as recited in claim 1 wherein the XML formatted data conduit transfers the XML formatted data via a firewire (IEEE 1394)-type standard.

14. A communication system for an interactive device as recited in claim 1 wherein the XML formatted data conduit transfers the XML formatted data wirelessly.

15. A communication method for an interactive device comprising:
initiating a transfer of XML formatted data from an interactive device framework of the interactive device;
receiving the XML formatted data at a data conduit coupled to one end of the interactive device;
transferring the XML formatted data over the data conduit; and
receiving the XML formatted data at an Internet framework coupled to a second end of the data conduit.

16. A communication method for an interactive device as recited in claim 15 wherein the transfer of XML formatted data is initiated from the Internet framework to the interactive device framework.

17. A communication method for an interactive device as recited in claim 15 wherein the transfer of XML formatted data goes both ways between the interactive device framework and the Internet framework.

18. A communication system for an interactive device as recited in claim 15 wherein the Internet framework further comprises applications that utilize the XML formatted data.

19. A communication system for an interactive device as recited in claim 15 wherein the interactive device framework further comprises applications that utilize the XML formatted data.

20. A communication system for an interactive device as recited in claim 15 wherein the interactive device is a handheld device.

21. A communication system for an interactive device as recited in claim 15 wherein the XML formatted data comprises an exercise object, a workout object and a program object.

22. A communication system for an interactive device as recited in claim 21 wherein the exercise object, the workout object and program object further comprise multimedia instructions.

23. A communication system for an interactive device as recited in claim 21 wherein the exercise object further comprises a template, a definition and an instance.

24. A communication system for an interactive device as recited in claim 21 wherein the workout object further comprises a definition and an instance.

25. A communication system for an interactive device as recited in claim 21 wherein the program object further comprises a definition and an instance.

26. A communication system for an interactive device as recited in claim 21 wherein the workout object is comprised of a plurality of exercise objects.

27. A communication system for an interactive device as recited in claim 26 wherein the program object is comprised of a plurality of workout objects.

28. A communication system for an interactive device as recited in claim 15 wherein the XML formatted data conduit transfers the XML formatted data via a universal serial bus-type standard.

29. A communication system for an interactive device as recited in claim 15 wherein the XML formatted data conduit transfers the XML formatted data via a firewire (IEEE 1394)-type standard.

30. A communication system for an interactive device as recited in claim 15 wherein the XML formatted data conduit transfers the XML formatted data wirelessly.

31. A data structure for use in an XML formatted data transfer comprising an exercise object, a workout object and a program object.

32. A data structure for use in an XML formatted data transfer as recited in claim 31 wherein the exercise object further comprises a template, a definition and an instance.

33. A data structure for use in an XML formatted data transfer as recited in claim 32 wherein the template further comprises a description, a categorization, a multimedia and a set structure.

34. A data structure for use in an XML formatted data transfer as recited in claim 32 wherein the definition further comprises a description, a categorization, a multimedia and a quantification and a data collect segment.

35. A data structure for use in an XML formatted data transfer as recited in claim 32 wherein the instance further comprises a description, a categorization, a multimedia, a quantification plan and an actual quantification.

36. A data structure for use in an XML formatted data transfer as recited in claim 31 wherein the workout object further comprises a definition and an instance.

37. A data structure for use in an XML formatted data transfer as recited in claim 36 wherein the definition further comprises a description, a categorization, a multimedia, a list of exercises and a data collect segment.

38. A data structure for use in an XML formatted data transfer as recited in claim 36 wherein the instance further comprises a description, a categorization, a multimedia, a quantification and a collected data segment.

39. A data structure for use in an XML formatted data transfer as recited in claim 31 wherein the program object further comprises a definition and an instance.

40. A data structure for use in an XML formatted data transfer as recited in claim 39 wherein the definition further comprises a description, a categorization, a multimedia and a quantification.

41. A data structure for use in an XML formatted data transfer as recited in claim 39 wherein the instance further comprises a description, a categorization, a multimedia and a list of workouts.

42. A communications protocol based on XML, said communications protocol characterized in that:
fitness data, generated from a program of workouts and exercises, is arranged in an object-oriented architecture, wherein said object-oriented architecture allows for an encapsulation of multimedia files.

43. A communications protocol based on XML, said communications protocol characterized in that:
a program object is comprised of a plurality of workout objects that in turn is based upon a plurality of exercise objects, wherein said program object, said workout object and said exercise object are encapsulated with multimedia files.
